(19) United States
(12) Patent Application Publication
(10) Pub. No.: US 2021/0233102 A1
(43) Pub. Date: Jul. 29, 2021

(54) PROVIDING PROMOTION RECOMMENDATIONS AND IMPLEMENTATION OF INDIVIDUALIZED PROMOTIONS

(71) Applicant: Salesforce.com, inc., San Francisco, CA (US)

(72) Inventors: Scot DeDeo, Burlington, MA (US); Jeremiah David Brazeau, Hudson, NH (US)

(21) Appl. No.: 16/774,229

(22) Filed: Jan. 28, 2020

(51) Int. Cl. G06Q 30/02; G06Q 30/06

(52) U.S. Cl. CPC G06Q 30/0224; G06Q 30/0211; G06Q 30/0631

(57) ABSTRACT

Systems and techniques for automated identification of promotions for use by users of a computerized commerce platform are provided. Historical data on the success of prior-implemented promotions is used to identify new promotions to suggest to a user.

### BACKGROUND

Commerce platforms often include backend systems on which a user may build a commercial site, such as a website that sells products or services. The commerce platform typically manages interactions with other systems, product and customer data storage, payment processing, and other functionality that is common across many sites, thereby providing a platform that may be used and customized by each user for their own products and services. Such commerce platforms may provide various configurations for users to implement promotions such as discounts, time-limited offers, coupons, and the like. These promotions may be defined generically by the commerce platform and selected by each user, or a user may define promotions for use within their own site, or combinations thereof.

### BRIEF DESCRIPTION OF THE DRAWINGS

FIG. 1 shows a computerized commerce platform according to an embodiment of the disclosed subject matter.

FIG. 2 shows an example process for implementing an individualized promotion according to an embodiment disclosed herein.

FIG. 3 shows an example process for selecting a potential promotion for a user's site according to an embodiment disclosed herein.

FIG. 4 shows an example computer architecture suitable for implementing embodiments disclosed herein.

### DETAILED DESCRIPTION

As used herein, a “user” may refer to a merchant, which may be a corporation or other organization, an individual, or any other entity that provides goods and/or services to its customers. A merchant may be a customer of another entity, such as a provider of a computerized commerce platform or similar framework that the merchant customizes to fits its particular business, and may sell goods and services to other businesses, individuals, or, more generally, any entity. For example, a computerized commerce platform may provide a framework that allows its customers to develop and deploy commercial websites, such as for the sales of goods and/or services. The platform may allow users to update inventory, prices, and the like; to offer various promotions to its own customers; to connect the user's commercial site to other data sources and/or to export data to other systems; to manage resources such as images, videos, text, and the like; and, more generally, to manage the presentation and operation of the commercial site and its interaction with the user's customers. A computerized commerce platform typically will be implemented on one or more servers and may be provided as a cloud-based service, as will be readily understood by one of skill in the art.

Insofar as conventional commerce platforms provide predefined promotions or allow users to define their own promotions, such promotions generally are basic and limited in scope. For example, a user may define a discount that is offered on some or all products on the user's site, assign a promotional price to individual products, or the like. However, commerce platforms typically do not provide any way for a user to know in advance which promotions may be successful or how successful the promotions may be, essentially leaving such calculations to each individual user. Many users do not track historical success rates or similar data for previous promotions or do not track such data accurately, resulting in significant duplication of effort even for a single user that may use similar promotions at various times.

For example, a site that sells seasonal clothing such as bathing suits may want to offer a promotion that will be likely to result in all clothing for a particular season being sold by a particular date, while still achieving a minimum threshold profit per item or overall within a category, product line, or the like. In a conventional system, the user may have to rely on his or her own records regarding previous sales, which may be incomplete or nonexistent, to determine whether a particular promotion is expected to result in the clothing being sold by the end of the season.

Embodiments disclosed herein provide systems and techniques that identify and suggest promotions to a user. Furthermore, the suggested promotions may include an indication of the expected success of the promotion. Continuing the example above, in contrast to a conventional system, embodiments disclosed herein may automatically identify a suitable promotion, determine the expected success of the promotion, such as an expected revenue level, and/or suggest one or more promotions to the user automatically or in response to a request for such a suggestion received from the user.

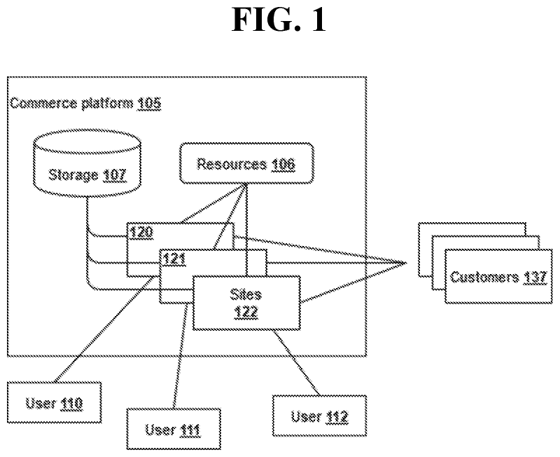

FIG. 1 shows an example arrangement according to embodiments disclosed herein. A computerized commerce platform 105 may provide a commerce platform to multiple users 110, 111, 112, etc., each of which may maintain one or more sites 120, 121, 122, respectively, on the platform. The sites may use common resources such as computing resources 106 such as memory and processing capability, data storage 107, and the like, but generally the platform 105 will include controls that prevent one user 110 from accessing the data of another user 111, 112 directly or indirectly. End-user customers 137 of the users 110, 111, 112 may access the sites 120, 121, 122 to purchase goods and/or services from the users 110. The users 110 may define the goods and/or services offered, set pricing, features, and the like, offer promotions, and otherwise control their own sites on the platform 105 as previously disclosed. In conventional systems, each of the sites 120, 121, 122 may be run, managed, and accessed separately from the others. That is, there may not be an overall commerce platform 105 that hosts and manages various functional aspects of the user sites. In other conventional systems, although a common host may exist to store the data associated with the sites 120-122 and provide access to customers 137, such as a website hosting service, typically such a platform does not provide any mechanism for one user and site 110/120 to benefit from any activities of another user and site 111/121. In contrast, embodiments disclosed herein may allow for one or more users 110-112 to benefit from promotions and other activities previously used by one or more other users 110-112, while still preventing any user from accessing data of another or otherwise obtaining technical or business data about the other users' sites.

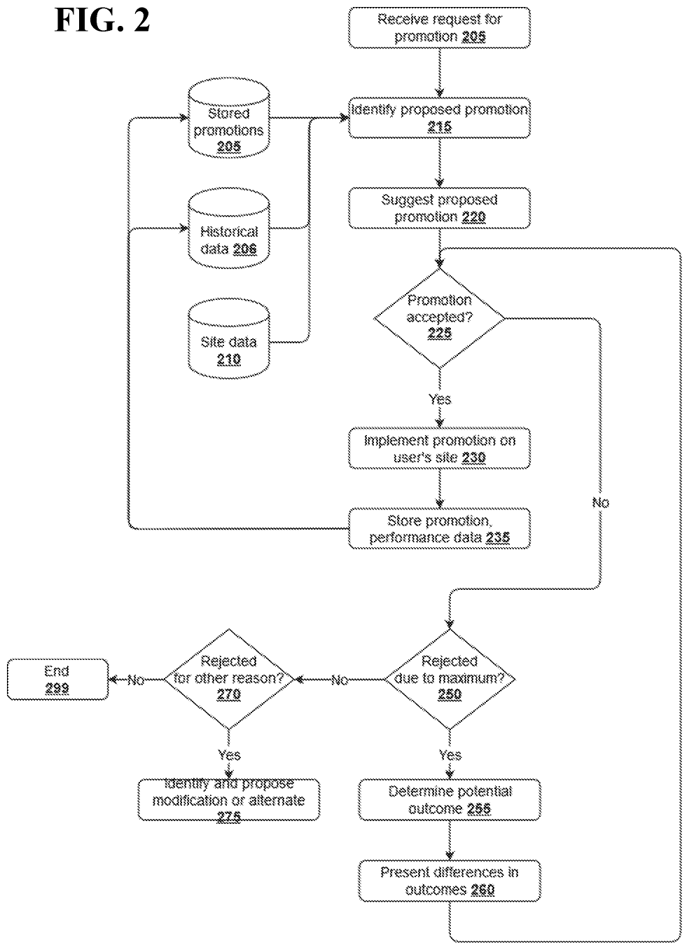

As previously disclosed, embodiments of the present subject matter may provide techniques to identify and propose specific promotions for a user 110-112 to use on their site 120-122 in order to increase sales, retain customers, solve issues with the end-user customer experience while using the site 120-122, or the like. FIG. 2 shows an example process for identifying and suggesting a promotion to a user of the commerce platform according to an embodiment. At 205, a computerized commerce platform may receive a request from a user for the platform to suggest a promotion. The request may be initiated by the user, or it may be made in response to a prompt by the platform. For example, the platform may present one or more potential promotions to the user via a user interface of the platform. Alternatively or in addition, the platform may provide a set of promotions that are available for the user to select while operating their site on the platform. As a specific example, the platform may store one or more promotions 205 that are always available for use, such as a percentage discount applied to products or types of products of the user's choice, free shipping or other benefit, extended warranty, free items when one or more items are purchased of the same or different types (“buy one get one” or “buy X get Y” type promotions), or the like. During normal operation of the system, the user may select and apply one or more such promotions on their site. According to embodiments disclosed herein, alternatively or in addition the user may request that the platform suggest one or more promotions to apply to the user's site, for example based on historical performance of the promotion in other contexts or within the user's site, and/or the expected performance of the promotion when applied on the user's site.

In response to the request from the user at 205, at 215 the platform may identify one or more proposed promotions for use on the user's site. Alternatively, the platform may periodically, intermittently, and/or automatically identify a promotion that may be suitable for a user's site, thereby beginning the process at 215 without requiring the user to first request that the platform suggest a promotion. The proposed promotion may be based on one or more promotions stored by the platform 205, historical data 206 indicating one or more outcomes of one or more promotions that were previously implemented by the platform on the user's site or one or more other sites on the platform, and data specific to the user's site.

The proposed promotion identified at 215 may be based on a desired result identified by the user or automatically determined by the platform. For example, where a clothing merchant wants to make sure that all summer styles are sold by the end of the summer season, the merchant user may request a promotion designed to sell as much summer-style inventory (items coded, tagged, or otherwise identified with a style of “summer”) as possible, while still maintaining a minimum profit for each item and/or overall. Alternatively or in addition, the promotion identified at 215 may be based on a trend or pattern identified by the platform based on the user's site and/or other sites on the platform. Continuing the example, even where the user has not requested that all summer styles be sold by the end of the season, the platform may identify the user's site as a clothing site based on information 210 about the site and, based on historical data 206, may determine that a particular discount or series of discounts timed with the clothing season (for example, stored as a date range or series of dates in the historical data 206) will be likely to increase sales and/or revenue of the site.

The stored promotions 205 may be of any type or character, and may apply to individual products, types or categories of products, or any combination thereof. The promotions may have been previously defined by developers and/or users of the platform, or they may have been automatically constructed by the platform based on rules encoded in the platform. Examples of promotions include discounts, bundling, “buy X get Y free” or “buy X get Y discount” type items, “threshold” discounts that apply when a customer purchases a minimum amount in a single order or series of orders, extended warranties or other benefits, additional technical support, coupons for later use, time- or product-limited offers, and the like. Generally each promotion may be defined in terms of one or more promotional factors, such as the percentage or absolute value of discount offered, the product or type of product to which the discount applies, a time duration for the promotion to be valid, a customer attribute that identifies customers to whom the promotion should apply, or the like.

The historical data 206 may include one or more outcomes of a promotion that was previously implemented on a user site. For example, historical data 206 may include a record of additional revenue generated as a result of a promotion, changes in sales volume, changes in unique or total customer visits to the site, or the like. The historical data 206 may include records linked to specific promotions 205, and/or records linked to types of promotions, sites or products on which the promotions were previously implemented, types of sites or products on which the promotions were previously implemented (when not defined by the promotions themselves), and the like.

As a specific, non-limiting example, a promotion may define a series of discounts to be applied to a particular type of product over the course of a time period, such as four weeks. Continuing the example above, a clothing merchant may want to make sure that as many bathing suits are sold before the end of the summer season (e.g., July 1) as possible. This desire may be explicitly expressed by the user, automatically identified by the platform based on the user's prior behavior or patterns identified by the platform for the user's site or similar sites, or combinations thereof. A promotion recommended at 215 may define a series of increasing discounts to be implemented each week leading up to July 1, at which point a special “clearance” special may be implemented that provides a higher discount for total purchases over a threshold amount. The platform may determine that the promotion will, either overall or with respect to each sale, result in a minimum profit level for the site. This information may be presented with the proposed promotion, as well as the historical data or a summary of the historical data on which the determination is based. In some cases, the historical data may include data indicting how the promotion performed, i.e., the outcome(s) of the promotion, when implemented on one or more sites belonging to other users on the platform. In this case the data may be anonymized such that the user obtains no specific information about the other sites. For example, the platform may indicate that “sites similar to this site” obtained a particular benefit when implementing the promotion, without providing any information about the “similar” site(s). In general, however, the platform itself may use any information about any sites and/or promotions implemented on those sites within the platform when identifying and recommending promotions to a user. This may result in some data used by the platform to identify a promotion at 215 being withheld, masked, or otherwise not provided to the user to whom the promotion is proposed at 215.

The site data 210 may include any information about the user's site and/or other sites on the platform. For example, the site data 210 may include high-level data such as a category or type of site, such as clothing, food or grocery, professional services, collectibles, and the like. It also may include more detailed data such as historical sales trends, demographic information about site visitors and customers, detailed product information, technical performance data, and the like. The platform may use site data 210 in conjunction with historical data 206 and promotion data 205 to identify suitable promotions for a site. For example, the platform may automatically identify certain patterns in the combinations of data and use those patterns to recommend promotions. As a specific example, the platform may determine that per-product promotions are more successful for collectible sites than a first-time discount, or that free shipping offers are more likely to result in increased sales when offered on Tuesdays or Wednesdays. In each case, the identified pattern of prior results may be used to recommend one or more promotions to a user. The site data 210 also may include customer-specific data that allows a user to define and use promotions that are customer-specific. For example, promotions may be tailored to behavior exhibited by an individual customer or type of customer (based on a known demographic attribute) in the past, information about the customer such as total prior spending or net value to the user's site, responses to prior promotions, or the like. Such customization may be included as part of the promotion specification and tracked through historical data 206 as for any other promotional feature(s).

At 220 the platform may suggest one or more promotions to the user. For example, the platform may provide a user interface that identifies the promotion and shows an expected result if the promotion was implemented on the user's site. The expected result may be given in terms of the user's site, or it may reference historical data, anonymized data for one or more similar sites, or the like. As a specific example, the site may indicate that “Sites similar to yours experienced an average increase of 22% for the same period when offering free shipping” or “Based on your historical sales data, offering a buy-one-get-one-free promotion may result in a 15% increase in sales; for products priced $5.99 or higher this will result in an average profit increase of 4%.” The user may be given an opportunity at 225, via the user interface, to accept and implement the promotion, in as much detail as presented and/or selected by the user. Continuing the prior example, the user may be able to accept the promotion and implement a buy-one-get-one-free promotion across his entire site, only for specific products, or only for products that meet the minimum pricing threshold. It will be understood that this example is merely illustrative and, more generally, at 220 and 225, any promotion, including any number of promotional factors, each of which may be accepted or rejected by the user. If the user accepts only a subset of promotional factors at 225, the platform may update the expected outcome of the promotion to show the change. In some cases the change may cause the promotion to be undesirable. For example, if the user implements a discount across all products instead of only the identified product types or price points, the total revenue may be expected to increase while total profit may be expected to decrease (for example based on historical data 206 for the promotion 205). In some embodiments the user may be provided the opportunity to proceed regardless of the updated outcomes and implement the promotion including the specific promotional feature(s) as indicated by the user.

If the promotion is accepted at 225, the promotion may be implemented on the user's site at 230. Implementation details may be specific to each promotion, but generally each promotional feature will result in changes made to one or more features of the user's site on the computerized commerce platform. For example, for a site-wide percentage discount, the site may be updated to indicate the discount on all items, and the purchase or checkout process may be updated to apply the discount to all items prior to receiving payment information from the end user customer. For more complex promotions, each promotional feature may be applied to each applicable feature of the user's site in turn. For example, a promotion may specify that total purchases over a threshold amount are entitled to a first discount, a total purchase over a second higher amount receives free shipping, and seasonal items are discounted based upon the date when each end user customer accesses the user's site on the platform. Each of these promotional features may result in the implementation of associated rules or other modifications to the user's site. First, the shopping cart and/or checkout process may be modified to implement the first discount level for carts or purchases that meet the first threshold. Later in the checkout process or in a shipping option display of the shopping cart, a second check may be implemented to see if each order or purchase meets the second threshold to qualify for free shipping. The seasonal discount may be applied on each product display page or similar interface, using a check that determines a date range into which the current date (when the end user customer accesses the site) falls, and display the appropriate discount. Each promotional feature also may result in a non-functional modification of information provided to end user customers. For example, customers may be informed of the discount, valid date ranges, qualification criteria, or other attributes of each promotional feature on appropriate interfaces of the user's site.

In contrast to conventional sales sites and platforms that require a user to implement and track their own promotions, embodiments disclosed herein also may allow for tracking the performance of each promotion implemented on the platform, whether it is implemented on a single user site or across multiple user sites. As used herein, the “performance” of a promotion refers to one or more measurable effects caused to a metric of interest to the user on whose site the promotion is implemented. For example a common performance metrics are changes in sales volume, revenue, and/or profit resulting from a promotion. However, other performance metrics may be used, including the effect on the technical performance of the site, the change in the number of visitors and/or purchasing customers (independently of the amount spent by individual or total customers), or the like. For example, a promotion may result in end user customers accessing pages or other interfaces the user's site in a different order or for different periods of time, which may result in a change to the apparent or actual responsiveness or other “feel” of the site to the customer. In general, any measurable attribute of the user's site may be tracked as performance data for the promotion. At 235, any implemented promotion and any associated performance data may be stored as a store promotion 205 and associated historical data 206 as previously disclosed. This data may then be used to recommend subsequent promotions to the same user and/or other users of the platform, as previously disclosed.

In some cases a user may reject a proposed promotion at 225 due to the proposed promotion exceeding a set of understood maximum or similar threshold for a promotional feature. For example, a user may not want to offer discounts on certain products above a certain maximum discount. As another example, a user may not want to offer “buy X get Y” type promotions due to concerns of reduced sales or customer engagement. If the user rejects the proposed promotion at 225, the platform may attempt to determine at 250 if the promotion was rejected due to the degree of promotional feature included in the proposed promotion. For example, the user interface may pose one or more questions to the user, such as “is the proposed discount too high,” “do you want to retain current inventory levels,” or the like. The questions may be determined automatically based upon the promotional features defined in the proposed promotion, or they may be predefined by a user, developer, or other original source of the promotion.

If it is determined at 250 that the user rejected the promotion due to the level or degree of one or more promotional features, the platform may determine an expected outcome of implementing the promotion as proposed on the user's site at 255. For example, the system may use historical data 206 and site data 210 for the user's site to calculate an expected increase in sales volume, based on a prior volume of the user's site and observed results of the promotion when implemented on similar sites. If no similar site data is available, the platform may use statistical projection techniques to predict an expected outcome or range of outcomes if the promotion is implemented on the user's site. This information may duplicate or expand on data presented to the user at 220. As a specific example, if a user indicates that a promotion is unacceptable because it exceeds a maximum discount that the user wants to offer, such as 15%, the platform may indicate that at a higher discount rate (e.g. 18% or 20%), the total revenue and/or profit is likely to increase.

At 260, the platform may present a comparison of expected outcomes if the promotion is implemented on the user's site, and if the promotion is not implemented (or an alternate promotion is implemented, such as a modification of the promotion by the user as previously disclosed). For example, the platform may present numerical or graphical representations of the sale volume, revenue, profit, user visits or other engagement, or the like over time for the user's site both with the promotion and in the absence of the promotion. The user then may be given another opportunity to accept the promotion, essentially returning to step 225 for further user interaction as previously disclosed. Where the user continues to reject the promotion at 225/250, the platform may attempt to determine if there are other promotional features that are unacceptable to the user. Alternatively or in addition, after presenting one or more potential outcome analyses the platform may continue on to 270. Similarly, if the user does not indicate that any of the promotional features are unacceptable but continues to reject the promotion, the process may continue to 270.

At 270, the platform may determine if the user rejected the proposed promotion for another reason. For example, the platform may determine that the user has a specific target metric that she wishes to meet with the promotion, which the analyses presented at 220, 260 failed to meet. If such a target or other desired outcome can be determined, the platform may identify and proposed a modification to the promotion and/or an alternate promotion at 275. For example, the platform may effectively return to step 215 to identify a proposed promotion that uses the determined desired outcome as a qualifying feature of the new promotion.

In some cases it may be determined that there is no addressable reason for the user to reject a promotion. As a specific example, the platform may have automatically proposed one or more promotions using the process as previously disclosed. The automatically-identified promotion may involve offering discounts to products that the user is contractually required to offer at a particular sale price, or is otherwise prevented from including the product(s) in a promotion. In this case the use may simply reject any such promotions, and alternative promotions or modifications to the proposed promotion will not be suitable to address the restrictions. In this case, or any other situation where the user rejects the available promotions, the process may end at 299.

In an embodiment, a user may elect to forego some or all of the user interaction portions of the process shown in FIG. 2. For example, a user may select a desired outcome or change to a metric of the user's site, such as total sale over time, profit margin, product volume, customer engagement, or any other measurable metric. The user may then authorize the platform to automatically implement any promotion that is determined to meet some or all of the defined target metric. For example, where a user specifies a desired higher profit level, the platform may implement one or more promotions that will increase the profit level of the user's site. The user also may specify limitations on such automatic implementation, such as excluding certain products or types of products from some or all promotions or types of promotions; limiting the number of promotions in effect at one time; limiting the types of promotions used; or the like.

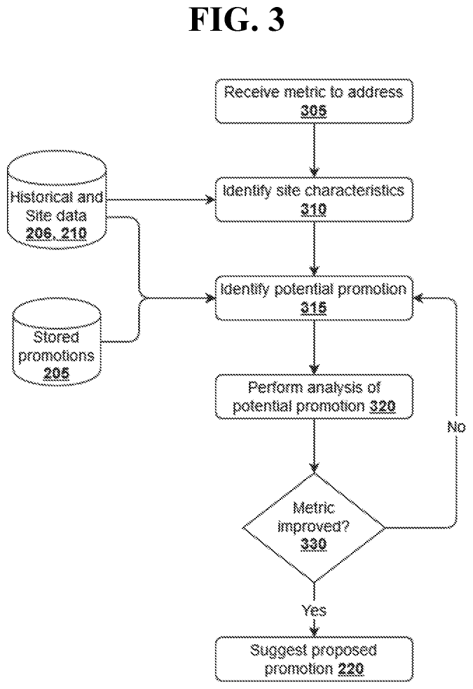

Various techniques may be used to identify promotions by the platform to propose to a user. FIG. 3 shows an example process for identifying a promotion suitable for a user's site on the computerized commerce platform. The process shown at 320 may be used, for example, as part of identifying a proposed promotion at 215 in FIG. 2. At 305, the platform may identify or receive an indication of a metric of a user's site to be improved via a promotion. In some cases, common or standard metrics may be pre-defined for such a use, including metrics such as revenue over time, profit over time, profit per order or per user, customer engagement, number of unique customer visits, or the like. Alternatively or in addition, a user may specify a metric that he wants to improve for his site. The specified metric may be selected from a group of metrics defined in the platform for the user's site, or it may be defined by the user, such as by selecting a calculated metric provided by a dashboard or other user interface of a computerized commerce platform 105. The metric also may be identified by the user when requesting a proposed promotion, such as at 205 in FIG. 2.

At 310, the platform may identify relevant site characteristics that could be modified by a promotion. As previously disclosed, such characteristics may include anything that can be the subject of a promotional feature, such as product pricing, shipping parameters, bundling options, and the like. Historical data 206 related to prior performance of promotions and of the site as a whole may be used to identify relevant characteristics, such as where historical site performance data indicates increased customer engagement when site-wide discounts are applied and/or higher profit when individual items are discounted. The historical and site data also may include data related to the performance of one or more promotions when applied to sites similar to the user's site, such as sites of the same type or category.

Based on the characteristic(s) identified at 310 and the stored promotions 205 available within the platform, a potential promotion may be identified at 315. The potential promotion may be one that has been used on the user's site previously, one that has been used on similar or related sites of other users previously, or a new promotion as previously disclosed. At 320, the potential promotion may be used as the basis of an analysis to determine a likely outcome of implementing the promotion on the user's site. For example, statistical analysis techniques, linear regression techniques, machine learning systems, or other analyses may be performed using the site characteristics and the promotional features of the proposed promotion as inputs. The analysis provides an indication of the expected change to the metric identified at 305. As previously disclosed, such as with respect to identification of a promotion at 215, various techniques may be used to identify a suitable promotion. For example, logistic regression or similar analysis may be performed using the historical data 206 and site data 210 to identify promotions that have been successful in the past and determine the expected performance of the promotions in the future. More specifically, a statistical comparison may be performed using any characteristics of the site and/or metrics of interest to determine how the site characteristics (as inputs to the analysis) may be expected to influence the metrics (as outputs), such as generated revenue, profit, engagement, and the like as previously disclosed.

If the metric is not improved at 330 according to the analysis at 315, 320, the process may repeat for a different potential promotion. If the metric is improved at 330, the potential promotion identified at 315 may be presented to the user, such as at 220 in FIG. 2.

Although FIG. 3 shows an example for identifying a promotion for a user's site, many other such processes may be used, and various steps shown in FIG. 3 may be modified or omitted, without departing from the scope of the disclosed subject matter. For example, some steps shown in FIG. 3 may be performed concurrently or in a different order than shown in the example, such as where a computerized commerce platform regularly tracks relevant site characteristics 310 and thus need not identify them after selection of a metric at 305. Similarly, the platform may maintain a current list of potential promotions that are likely to apply to particular sites or types of sites on the platform, effectively performing the analysis 315, 320, 330 concurrently with other operations and suggesting an appropriate promotion to the user at 220, which has already been identified by the platform before the user requests a proposed promotion.

Embodiments disclosed herein may be particularly suited to implementation on computerized systems such as a computerized commerce platform, which can efficiently and/or automatically track and analyze promotion performance over time, compare promotion performance across users, sites, and customers, and otherwise manage and manipulate a large number of users, sites, promotions, and customers. For example, a single user may be able to manage a single promotion at a time on their site. However, they may not be able to accurately track and analyze the behavior of a large number of customers during the promotion, or to separate customer behavior due to the promotion from behavior that results from other effects such as the time of year, the time each customer accesses the site, and so on. In contrast, a computerized commerce platform as disclosed herein may easily track such data and rapidly perform the complex statistical analyses required to perform such evaluations. Embodiments disclosed herein also may provide additional benefit in multi-user systems since they may use the performance results of promotions implemented on one user's site when evaluating the expected performance of the same or similar promotions on other user's sites as previously disclosed. Furthermore, historical performance data from multiple sites may be used to judge the expected performance of a promotion on a user's site and/or to modify or develop new promotions that may be suitable for use on one or more users' sites.

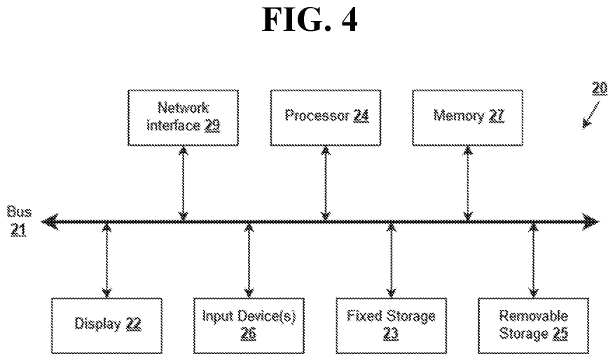

Embodiments disclosed herein may be implemented in and used with a variety of component and network architectures. FIG. 4 is an example computing device 20 suitable for implementing aspects of the presently disclosed subject matter as previously disclosed, including but not limited to a personal computing device that may be used by a user or a customer to access sites on a computerized commerce platform, a server or cloud computing component suitable for hosting and/or implementing the commerce platform, or the like. The device 20 may be, for example, a desktop or laptop computer, a mobile computing device such as a phone or tablet, or the like, a headless or other server architecture, or the like.

The device 20 may include a bus 21 which interconnects major components of the computer 20, such as a central processor 24, a memory 27 such as Random Access Memory (RAM) or the like, a user display or other output device 22 such as a display screen, one or more user input devices 26, which may include one or more controllers and associated user input devices such as a keyboard, mouse, touch screen, and the like, a fixed storage 23 such as a hard drive, flash storage, and the like, a removable storage unit 25 operative to control and receive an optical disk, flash drive, and the like, and a network interface 29 operable to communicate with one or more remote devices via a suitable network connection.

The bus 21 allows data communication between the central processor 24 and one or more memory components. Applications resident with the computer 20 are generally stored on and accessed via a computer readable medium, such as a fixed storage 23 and/or a removable storage 25 such as an optical drive, floppy disk, or other storage medium.

The fixed storage 23 may be integral with the computer 20 or may be separate and accessed through other interfaces. The network interface 29 may provide a direct connection to a remote server via a wired or wireless connection. The network interface 29 may provide such connection using any suitable technique and protocol as will be readily understood by one of skill in the art, including digital cellular telephone, Wi-Fi, Bluetooth(R), near-field, and the like. For example, the network interface 29 may allow the computer to communicate with other computers via one or more local, wide-area, or other communication networks. Other components may be included and some described components may be omitted without departing from the scope or content of the disclosed embodiments. For example, in embodiments in which the disclosed systems and methods are embodied in a postage meter, the meter may include one or more ascending and/or descending registers as is understood in the art.

More generally, various embodiments of the presently disclosed subject matter may include or be embodied in the form of computer-implemented processes and apparatuses for practicing those processes. Embodiments also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, such that when the computer program code is loaded into and executed by a computer, the computer becomes an apparatus for practicing embodiments of the disclosed subject matter. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, such that when the computer program code is loaded into and executed by a computer, the computer becomes an apparatus for practicing embodiments of the disclosed subject matter. When implemented on a general-purpose microprocessor, the computer program code segments configure the microprocessor to create specific logic circuits.

In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general-purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A method comprising:
identifying a first proposed promotion from among a plurality of promotions within a computerized commerce platform, wherein:
the computerized commerce platform comprises a framework to develop and deploy a commercial site; and
the first proposed promotion is identified based:
at least in part on historical data that indicates the success of a second promotion previously implemented on the computerized commerce platform, the second promotion being different from the first proposed promotion; and
at least one feature of a first commercial site of a first user of the computerized commerce platform;
providing, to the first user, the first proposed promotion and an indication of an expected outcome of the proposed promotion when applied on the first commercial site;
in response to a selection of the first proposed promotion by the first user, implementing the first proposed promotion on the first commercial site of the first user implemented on the computerized commerce platform;
storing data indicating the success of the first proposed promotion during operation of the first commercial site of the first user;
responsive to a request from a second user, identifying a second proposed promotion from among the plurality of promotions within the computerized commerce platform, the second proposed promotion being identified based at least in part on the data indicating the success of the first proposed promotion.

2. The method of claim 1, wherein the step of identifying the first proposed promotion is responsive to receiving, by the computerized commerce platform, a request from the first user to suggest a promotion defining an incentive for a customer to purchase an item from the first user via the first commercial site of the first user.

3. The method of claim 1, wherein the second user is different than the first user.

4. The method of claim 1, wherein the second proposed promotion comprises a different promotional factor than the first proposed promotion.

5. The method of claim 1, wherein the second proposed promotion comprises at least one promotional factor that is included in the first proposed promotion.

6. The method of claim 1, wherein the historical data that indicates the success of the second promotion comprises data for a site of another user, different than the first user, implemented on the computerized commerce platform.

7. The method of claim 6, wherein the second promotion is a disabled promotion.

8. The method of claim 1, wherein the expected outcome comprises an expected effect on revenue generated due to implementation of the first proposed promotion on the first commercial site of the first user.

9. The method of claim 8, wherein the expected outcome further comprises an expected time period over which the expected effect on revenue generated due to implementation of the first proposed promotion will occur.

10. The method of claim 8, wherein the expected effect is determined based upon one or more factors selected from the group consisting of:
a price of an item to which the first proposed promotion applies;
a time period during which the first proposed promotion applies;
a time period during which the first commercial site of first user is accessed by the second user;
a category to which the site of the first user belongs;
a season during which the first proposed promotion is implemented on the first commercial site of the first user; and
a comparison of the first commercial site of the first user to a site on which the second promotion was previously implemented.

11. The method of claim 1, wherein the first proposed promotion excludes at least one item identified by the first user as ineligible for promotions.

12. The method of claim 1, further comprising:
receiving an indication of a maximum promotional factor from the first user;
determining that the expected outcome of the first proposed promotion will be greater if the maximum promotional factor is exceeded; and
providing an indication of a difference between the expected outcome when the first proposed promotion does not include a promotional factor that exceeds the maximum promotional factor and the expected outcome when the first proposed promotion includes a promotional factor that exceeds the maximum promotional factor.
